(19) United States
(12) Patent Application Publication
(10) Pub. No.: US 2018/0081192 A1
(43) Pub. Date: Mar. 22, 2018

(54) New way of placing reticle hashmarks

(71) Applicant: Kevin Kai Qu, Overland Park, KS (US)

(72) Inventor: Kevin Kai Qu, Overland Park, KS (US)

(21) Appl. No.: 15/233,504

(22) Filed: Sep. 20, 2016

(51) Int. Cl. G02B 27/32; F41G 1/38; F41G 3/08

(52) U.S. Cl. CPC G02B 27/32; F41G 3/08; F41G 1/38

(57) ABSTRACT

The present invention creates a new way of arranging harsh marks on a reticle that is to have the 2/10^{th} and the 4/10^{th} hash mark placed either above or below the horizontal base sighting line (See FIG. 2. Line 26) or on the left or right side of the vertical sighting base line (See FIG. 2. Line 27) at any unit of measurement of a segment and have the 6/10^{th} and the 8/10^{th} hash mark placed at the opposite side of the horizontal base sighting line (See FIG. 2. Line 26) and the vertical sighting lines (See FIG. 2. Line 27) compared with the 2/10^{th} and the 4/10^{th} marks.

This new way of placing hash marks at every 2/10^{th} of the unit of measurement allows a user to quickly identify and discern which numerical value a hash mark represents on the horizontal base sighting line and vertical sighting line without physically counting the numerical value of a hash mark in a linear way. The said hash marks are being referred to the vertical or horizontal dividing lines that divide a segment at any unit of measurement of a generally horizontal base sighting line or a generally vertical sighting line into equal fractional parts of the segment.

### FIELD OF THE INVENTION

This invention relates to optical sighting devices, such as riflescopes, red dot sights, prism scopes, spotting scopes and other optical sighting devices. The principal of the invention is to provide an improvement of placing or arranging hash marks of a reticle used in above optical sighting devices so that a user can quickly discern the numerical value a hash mark stands for and decide which hash mark should be used for the user's specific application.

### BRIEF DESCRIPTION OF THE PRIOR ART

A traditional way of having hash marks placed is having the 2/10^{th} hash marks at any unit of measurement at identical length and shape across the generally horizontal base sighting line or the generally vertical sighting line of the reticle in FIG. 1. The unit of the length measurement in FIG. 1 is MOA (minute of angle, an angular unit of measurement). In FIG. 1, the cross hair 10 is the center of the reticle, and hash mark 11, 12, 13, 14 represent the distance to the center of the reticle at 0.2 MOA, 0.4 MOA, 0.6 MOA, and 0.8 MOA respectively. The hash marks 11, 12, 13, 14 are identical in height and placed on the horizontal base sighting line 16 with equal length above and below horizontal base sighting line 16 in a linear way. When a user looks at the reticle through a riflescope and tries to get the numerical value of a hash mark (See FIG. 1 line 11, 12, 13, 14 for examples) and what numerical values each hash mark represents within a segment of the horizontal base sighting line 16 in FIG. 1 or the vertical sighting line 17 in FIG. 1 The user must count and distinguish the position of a hash mark and the numerical value a hash mark represents in a linear way among those hash marks with identical length and shape. During a critical time at a shooting competition or other applications, counting the position of a hash mark in a linear way while being able to tell the numerical value of each hash mark quickly and correctly can be very challenging for the user.

### SUMMARY OF THE INVENTION

The present invention creates a new way of arranging harsh marks on a reticle that is to have the 2/10^{th} and the 4/10^{th} hash mark placed either above or below the horizontal base sighting line (See FIG. 2. Line 26) or on the left or right side of the vertical sighting base line (See FIG. 2. Line 27) at any unit of measurement of a segment and have the 6/10^{th} and the 8/10^{th} hash mark placed at the opposite side of the horizontal base sighting line (See FIG. 2. Line 26) and the vertical sighting lines (See FIG. 2. Line 27) compared with the 2/10^{th} and the 4/10^{th} marks.

This new way of placing hash marks at every 2/10^{th} of the unit of measurement allows a user to quickly identify and discern which numerical value a hash mark represents on the horizontal base sighting line and vertical sighting line without physically counting the numerical value of a hash mark in a linear way. The said hash marks are being referred to the vertical or horizontal dividing lines that divide a segment at any unit of measurement of a generally horizontal base sighting line or a generally vertical sighting line into equal fractional parts of the segment.

### BRIEF DESCRIPTION OF THE DRAWINGS

FIG. 1: is a diagram of a traditional reticle of a riflescope or other sighting devices

FIG. 2: is a diagram of a new reticle design where the 2/10^{th} hash marks are placed in a new way created in the present invention

FIG. 3: shows a blow-up portion of the hash mark placement from FIG. 2

FIG. 4: is another diagram of the new reticle design where the 2/10^{th} hash marks are placed in another way created in present invention

FIG. 5: shows a blow-up portion of the hash mark placement from FIG. 4

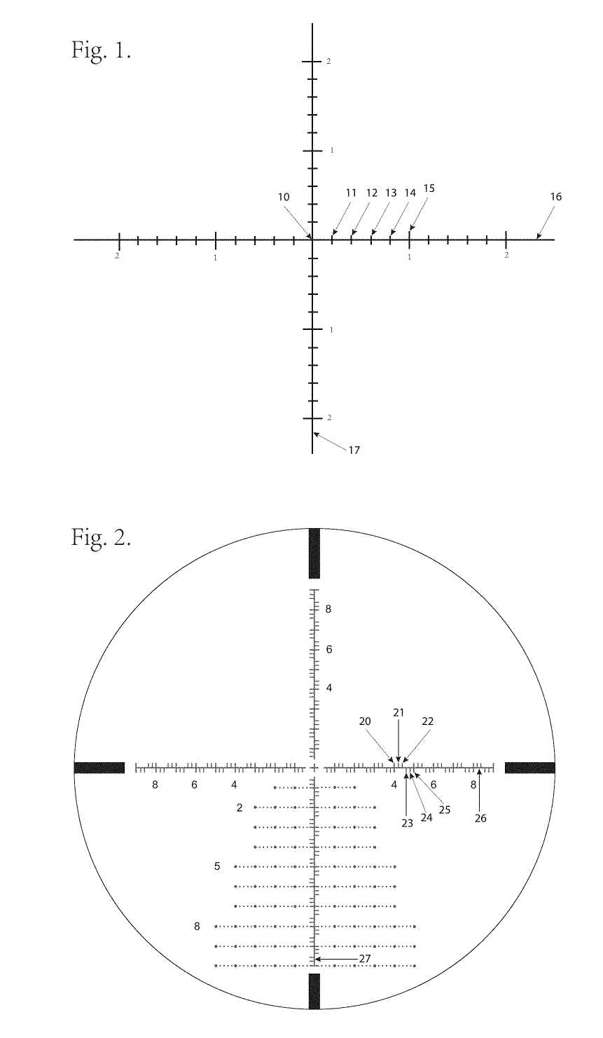

### DETAILED DESCRIPTION OF THE PREFERRED EMBODIMENTS

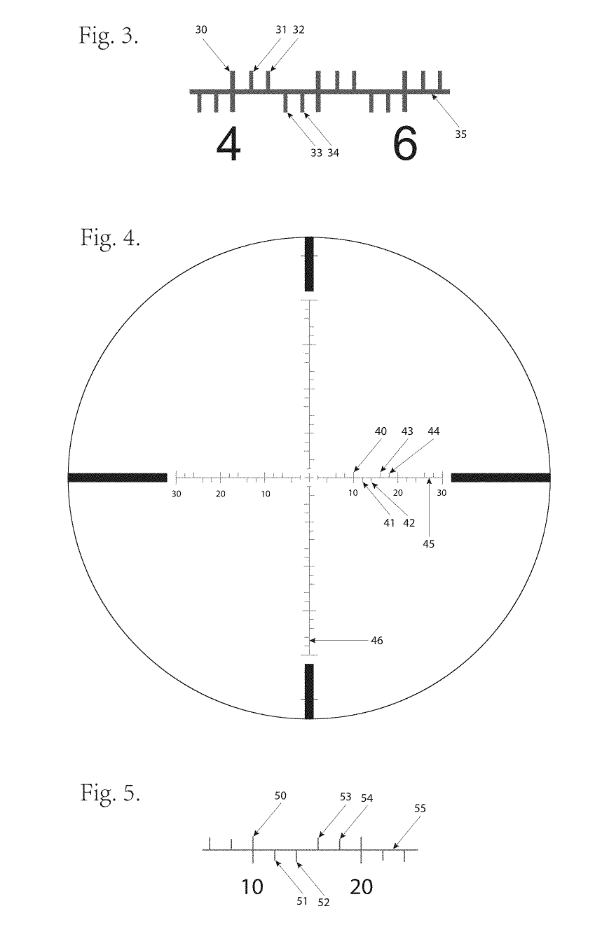

The reticle in FIG. 2 is in MIL (an angular unit of measurement) and has smallest unit in 0.2 MIL. In FIG. 2, line 20 is the 4^{th} MIL mark; line 21 stands for 4.2 MIL, line 22 for 4.4 MIL, line 23 for 4.6 MIL, and line 24 for 4.8 MIL. In FIG. 2, the new way of placing hash marks of the reticle is to have the 2/10^{th} mark line 21 and the 4/10^{th} mark line 22 placed above the horizontal base sighting line 26, and the 6/10^{th} mark line 23 and the 8/10^{th} mark line 24 placed below the horizontal base sighting line 26. This new way of placing hash marks at 2/10^{th} of the unit of measurement allows a user to quickly identify the numerical value of a hash mark represents within the segment that is from the 4^{th} MIL line 20 to the 5^{th} MIL line 25. Line 21 as 4.2 MIL is the first mark above the horizontal base sighting line right to line 20; line 22, as 4.4 MIL, is the second mark in the middle above the horizontal base sighting line without any hash marks from its right; line 23, as 4.6 MIL, is the first mark below the horizontal base sighting line 26 with no hash marks in front it; line 24, as 4.8 MIL, is the mark below the horizontal base sighting line left to the 5^{th} MIL mark line 25. FIG. 3 is the blow-up portion of the reticle between the 4^{th} MIL and the 6^{th} MIL. The hash marks line 31 and line 32 are above the horizontal base sighting line 35, which can easily be discerned for the numerical value 4.2 MIL and 4.4 MIL. The hash marks line 33 and line 34 that are below the horizontal base sighting line 35 can be quickly recognized as the 4.6^{th} MIL and the 4.8^{th} MIL mark.

In FIG. 4, the reticle is represented in MOA. Line 40 is the 10^{th} MOA mark; line 41 and line 42 are placed below the horizontal base sighting line 45 and are the 12^{th} MOA and 14^{th} MOA hash mark respectively. Line 43 and line 44 are placed above the horizontal base sighting line 45 and are the 16^{th} MOA and 18^{th} MOA hash mark respectively.

FIG. 5 is a blown-up portion of the reticle between the 10^{th} MOA and the 20^{th} MOA hash mark. The hash mark line 51 and line 52 are below the horizontal base sighting line 55 and are the 12 MOA mark and the 14^{th} MOA mark respectively. The hash mark line 53 and line 54 are the 16^{th} MOA mark and the 18th MOA mark respectively.

I claim:

1. In a reticle of riflescope or other sighting devices such as riflescopes, red dot sights, prism scopes, spotting scopes and other optical sighting devices and having means thereon for using the said reticle to hold over for bullet drop or wind correction or to range distance to a target, said reticle including a generally vertical sighting line and a generally horizontal base sighting line, the improvements include placing the 2/10^{th} and 4/10^{th} hash mark within a segment of said vertical sighting line or said horizontal base sighting line at any unit of measurement above or below said horizontal base sighting line or on left or right side of said vertical sighting line; placing the 6/10^{th} and 8/10^{th} hash mark on the opposite side of said horizontal base sighting line and said vertical sighting line compared with said 2/10^{th} and 4/10^{th} hash mark.

2. Said 2/10^{th} and 4/10^{th} hash mark form a T shape connection horizontally or vertically with said vertical sighting line or said horizontal base sighting line respectively at one side. Said 6/10^{th} and 8/10^{th} hash mark form a T shape connection horizontally or vertically with said vertical sighting line or said horizontal base sighting line respectively at the opposite side of said horizontal base sighting line or said vertical sighting line compared with relative positions of said 2/10^{th} and 4/10^{th} hash marks.

3. The length of said segment in claim 1, that is divided by said 2/10^{th}, 4/10^{th}, 6/10^{th}, and 8/10^{th} hash marks, of said horizontal base sighting line or said vertical sighting line can be but not limited to 1, 10, 100 or any other lengths at any unit of measurement
